(19) United States
(12) Patent Application Publication
(10) Pub. No.: US 2026/0341236 A1
(43) Pub. Date: Oct. 29, 2026

(54) LIQUID-CRYSTAL DISPLAY DEVICE, LIQUID-CRYSTAL DISPLAY METHOD, AND PROGRAM

(71) Applicant: EIZO Corporation, Hakusan-shi, Ishikawa (JP)

(72) Inventors: Kunio KAWAMURA, Hakusan-shi (JP); Hiroya SAITO, Hakusan-shi (JP); Takahito KANETA, Hakusan-shi (JP); Kazuhiro KATA, Hakusan-shi (JP)

(73) Assignee: EIZO Corporation, Hakusan-shi, Ishikawa (JP)

(21) Appl. No.: 19/103,891

(22) PCT Filed: Jul. 12, 2023
(86) PCT No.: PCT/JP2023/025719

§ 371 Date: Feb. 14, 2025

(30) Foreign Application Priority Data
Oct. 4, 2022 (JP) 2022-160192

(51) Int. Cl. G09G 3/34

(52) U.S. Cl. CPC G09G 3/3406; G09G 3/342; G09G 2320/0247; G09G 2320/0257; G09G 2320/0285; G09G 2360/16

(57) ABSTRACT

A liquid-crystal display device that performs a light source control of a backlight, including: a correction data acquisition unit; and a light source control unit. The liquid-crystal display device is configured to reduce a flicker caused by a difference in liquid-crystal response speed between a pixel where a pixel value increases and a pixel where a pixel value decreases during a transition from a first frame to a second frame, the correction data acquisition unit is configured to acquire a correction data for reducing an occurrence of the flicker based on the pixel values of the first and second frames, the light source control unit is configured to acquire a backlight correction value based on the correction data, and the backlight correction value is used for the light source control of the backlight during a predetermined period between the first and second frames.

### TECHNICAL FIELD

The present invention relates to a liquid-crystal display device, a liquid-crystal display method, and a program.

### BACKGROUND

When a frame displayed on a liquid crystal display device transitions, a pixel value (luminance) of each pixel changes according to a frame being displayed. Here, because a response speed of a pixel value of a pixel where a pixel value increases differs from a response speed of a pixel value of a pixel where a pixel value decreases, a flicker may occur in the liquid-crystal display device when the frame transitions, leading to a decrease in image quality (see, for example, Patent Literature 1).

### PATENT LITERATURE

[Patent Literature 1] US Patent Application Publication No. 2011/0199287

### SUMMARY

The degree where the flicker occurs varies according to the frame displayed on the liquid-crystal display device. For example, the flicker is likely to occur in a frame called a dot mesh where a white pixel and a black pixel are arranged alternately.

The present invention has been made in consideration of the above circumstances, and aims to provide a liquid-crystal display device, a liquid-crystal display method, and a program capable of reducing a flicker.

According to the present invention, the following liquid-crystal display device is provided.
[1] A liquid-crystal display device that performs a light source control of a backlight, comprising: a correction data acquisition unit; and a light source control unit, wherein the liquid-crystal display device is configured to reduce a flicker caused by a difference in liquid-crystal response speed between a pixel where a pixel value increases and a pixel where a pixel value decreases during a transition from a first frame to a second frame, the correction data acquisition unit is configured to acquire a correction data for reducing an occurrence of the flicker based on the pixel values of the first and second frames, the light source control unit is configured to acquire a backlight correction value based on the correction data, and the backlight correction value is used for the light source control of the backlight during a predetermined period between the first and second frames.

In the present invention, the light source control unit is configured to acquire a backlight correction value based on a correction data for reducing an occurrence of a flicker, and when a frame is displayed, the backlight is driven at a setting value that takes into account this backlight correction value, thereby reducing the flicker.

Various embodiments of the present invention are described below. Any of the embodiments described below can be combined with one another.
[2] The liquid-crystal display device of [1], wherein the correction data acquisition unit acquires the correction data using a liquid-crystal response characteristic where the pixel values of the first frame and the pixel values of the second frame are associated, and the liquid-crystal response characteristic is a liquid-crystal response speed or a liquid-crystal response time.
[3] The liquid-crystal display device of [2], wherein the correction data acquisition unit acquires the correction data using an estimated pixel value based on the liquid-crystal response characteristic, the estimated pixel value is a pixel value at an intermediate timing, and the intermediate timing is a timing between the first and second frames.
[4] The liquid-crystal display device of any one of [1] to [3], wherein the light source control unit is configured to acquire the backlight correction value to be applied to a pixel of in-region pixels based on the correction data of the in-region pixels, and the in-region pixels are composed of a plurality of pixels included in a predetermined region of the first and second frames.
[5] The liquid-crystal display device of [4], wherein the correction data acquisition unit is configured to acquire the correction data based on a difference between a first and a second statistical value, the first statistical value is a statistical value based on pixel values of the plurality of pixels of the in-region pixels in the first frame, the second statistical value is a statistical value based on pixel values of the plurality of pixels of the in-region pixels at an intermediate timing, and the intermediate timing is a timing between the first and second frames.
[6] The liquid-crystal display device of [5], wherein the statistical value is a mean value, a median value, or a value acquired based on a histogram.
[7] The liquid-crystal display device of [4], wherein the correction data acquisition unit is configured to extract a specific pixel of the in-region pixels, and is configured to acquire the correction data for the extracted specific pixel, and the light source control unit is configured to acquire the backlight correction value based on the correction data for the specific pixel.
[8] The liquid-crystal display device of any one of [4] to [7], wherein the correction data acquisition unit is configured to acquire a flicker amount for each of the predetermined regions, and is configured to determine whether or not to use the correction data and the backlight correction value for the predetermined regions based on the flicker amount, and the flicker amount corresponds to a degree where the flicker occurs in the predetermined regions during the transition from the first frame to the second frame.
[9] The liquid-crystal display device of any one of [1] to [8], wherein the first and second frames are dot mesh images.
[10] The liquid-crystal display device of any one of [1] to [9], wherein the light source control is a local dimming control, and the backlight correction value is used for the local dimming control of the backlight corresponding to at least a pixel including an attention pixel during a predetermined period between the first and second frames.
[11] A liquid-crystal display method that that performs a light source control of a backlight, comprising: a correction data acquisition step; and a backlight correction value acquisition step, wherein the liquid-crystal display method reduces a flicker caused by a difference in liquid-crystal response speed between a pixel where a pixel value increases and a pixel where a pixel value decreases during a transition from a first frame to a second frame, in the correction data acquisition step, a correction data for reducing an occurrence of the flicker is acquired based on the pixel values of the first and second frames, in the backlight correction value acquisition step, a backlight correction value is acquired based on the correction data, and the backlight correction value is used for the light source control of the backlight during a predetermined period between the first and second frames.
[12] A program causing a computer to execute the liquid-crystal display method of [11].

### BRIEF DESCRIPTION OF DRAWINGS

FIG. 1 is a schematic diagram showing a liquid-crystal display device 100 and an output device 200 that outputs a video signal according to an embodiment.

FIG. 2 is a functional block diagram of the liquid-crystal display device 100 shown in FIG. 1.

FIG. 3 shows a frame F1 as a previous frame.

FIG. 4 shows pixel values at each coordinate of the frame F1 shown in FIG. 3.

FIG. 5 shows a frame F2 as a subsequent frame.

FIG. 6 shows pixel values at each coordinate of the frame F2 shown in FIG. 5.

FIG. 7 shows an example of a lookup table (LUT) that is associated with a pixel value of the previous frame and a pixel value of the subsequent frame.

FIG. 8 shows pixel values of each coordinate at an intermediate timing.

FIG. 9 is a graph for explaining how the pixel value of each coordinate (here, coordinate (1, 1)) is estimated to change over time.

FIG. 10 is a flowchart for explaining various calculation processes when a backlight correction value Bc is acquired.

FIGS. 11A to 11C show frames the F1 and F2 with different flicker susceptibility. The Frame F1 in FIGS. 11A to 11C is the same, and the frame F2 in FIGS. 11A to 11C is different. FIG. 11A shows the case where the flicker is most likely to occur among FIGS. 11A to 11C. FIG. 11B shows the case where the flicker occurs slightly, and FIG. 11C shows the case where the flicker is least likely to occur among FIGS. 11A to 11C.

FIG. 12A shows a transition line G of an average value of an estimated pixel value when the pixel value transitions as shown in FIG. 11A. FIG. 12A shows differences Ar1 to Ar9 corresponding to the difference between the transition line G of an average value of an estimated pixel value and a reference line RL passing through a timing of the subsequent frame. FIG. 12B shows the transition line G of an average value of an estimated pixel value when the pixel value transitions as shown in FIG. 11B. FIG. 12C shows the transition line G of an average value of an estimated pixel value when the pixel value transitions as shown in FIG. 11C.

FIG. 13 is a flowchart for explaining various calculation processes when the backlight correction value Bc according to the modified example 1 of the embodiment is acquired.

FIG. 14 is a flowchart for explaining various calculation processes when the backlight correction value Bc according to the first method of the modified example 2 of the embodiment is acquired.

FIG. 15A shows a predetermined region Rg of the frame F1 as the previous frame and a predetermined region Rg of the frame F2 as the subsequent frame, which are used in the first method of the modified example 2 of the embodiment. FIG. 15B shows the difference D of the pixel values of the frames F1 and F2. FIG. 15C shows the liquid-crystal response characteristic (liquid-crystal response time) of each pixel calculated from the LUT. FIG. 15D shows an estimated transition amount of a pixel value of each pixel at the intermediate timing. FIG. 15E shows an ideal value of the transition amount of the pixel value of each pixel at the intermediate timing. FIG. 15F shows an insufficient transition amount data.

FIG. 16 shows a straight line L1 for explaining how a pixel value of each coordinate (here, coordinate (2, 2)) is estimated to change over time, and a straight line L2 showing an ideal transition of each coordinate (here, coordinate (2, 2)).

FIG. 17 is a functional block diagram of a liquid-crystal display device 100 according to a modified example 5 of the embodiment.

### DETAILED DESCRIPTION

Hereinafter, an embodiment of the present invention will be described with reference to the drawings. Various features shown in the following embodiments can be combined with each other. Also, each feature can be an invention independently.

### 1. Description of Overall Configuration

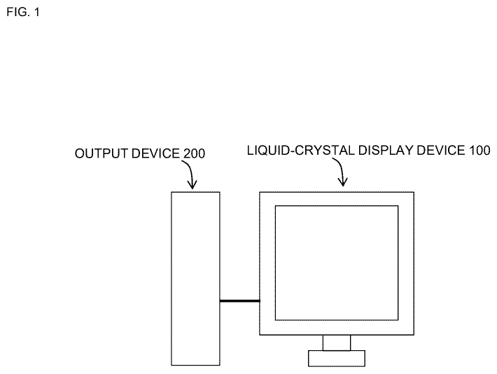

The overall configuration of a liquid-crystal display device 100 according to an embodiment will be described. In the embodiment, the liquid-crystal display device 100 is communicably connected to an output device 200 as shown in FIG. 1. It is noted that the output device 200 is an information processing device (for example, a personal computer) that is configured to be able to output a video signal F. In addition, in the embodiment, the liquid-crystal display device 100 is described as acquiring the video signal F from the output device 200 as an external device, but this is not limited to this, and the video signal F may be stored in advance in the liquid-crystal display device 100, and the liquid-crystal display device 100 may process the video signal F.

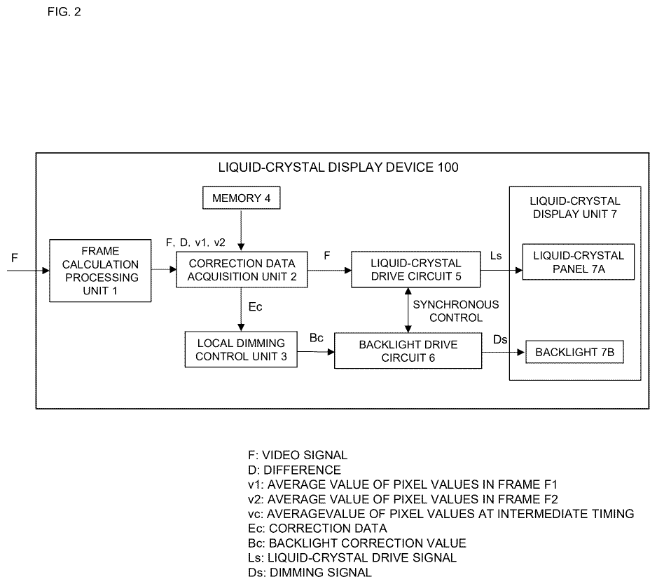

In the embodiment, the liquid-crystal display device 100 is composed of a liquid-crystal monitor. As shown in FIG. 2, the liquid-crystal display device 100 includes a frame calculation processing unit 1, a correction data acquisition unit 2, a local dimming control unit 3 as a light source control unit, a memory 4, a liquid-crystal drive circuit 5, a backlight drive circuit 6, and a liquid-crystal display unit 7 having a liquid-crystal panel 7A and a backlight 7B. It is noted thar the memory 4 stores data used in the processing of the correction data acquisition unit 2.

Each of the components of the liquid-crystal display device 100 may be realized by a software or by a hardware. When each of the components of the liquid-crystal display device 100 is realized by a software, various functions can be realized by the CPU executing a computer program. The program may be stored in a built-in storage unit or a non-transitory computer-readable recording medium. In addition, the program stored in an external storage unit may be read and realized by so-called cloud computing. When each of the components of the liquid-crystal display device 100 is realized by a hardware, it can be realized by various circuits such as ASIC, FPGA, or DRP (Dynamically Reconfigurable Processor). In this embodiment, various information and concepts that encompass this are handled, which are represented by high and low signal values as a binary bit collection consisting of 0 or 1, and communication and calculations can be performed by the above-mentioned software or hardware aspects.

The liquid-crystal display device 100 has a function of acquiring a backlight correction value Bc used when the backlight 7B is driven in order to reduce a flicker. Here, the flicker refers to flickering that occurs in the liquid-crystal display unit 7 due to pixel response delay when a frame transitions. In other words, the flicker corresponds to a gap in pixel values (luminance) between previous and subsequent frames due to the difference in liquid-crystal response speed between a pixel where a pixel value (luminance) increases and a pixel where a pixel value (luminance) decreases when a frame transitions. The above-mentioned backlight correction value Bc makes it possible to reduce this gap.

Here, a frame transition corresponds to a transition from a frame of any timing (an example of a first frame) to a frame of the next timing (an example of a second frame).

Also, the pixel response delay means that there is a difference in response between pixels according to the operation details of the pixels of the liquid-crystal display unit 7. In this embodiment, the liquid-crystal display unit 7 is described as having a slower response speed when the pixel value of each pixel of the liquid-crystal display unit 7 increases than the response speed when the pixel value of each pixel of the liquid-crystal display unit 7 decreases. In other words, when a frame transition occurs, a pixel where a pixel value decreases reaches the desired pixel value more quickly than a pixel where a pixel value increases. This embodiment is not limited to this, and can also be applied to a case where the response speed of each pixel of the liquid-crystal display unit 7 when the pixel value of each pixel of the liquid-crystal display unit 7 decreases is slower than the response speed when the pixel value of each pixel of the liquid-crystal display unit 7 increases.

In an embodiment, an increase in pixel value refers to a pixel value (relatively low value) of a pixel at any coordinate in a frame at any timing (an example of the first frame) increasing to a pixel value (relatively high value) of a pixel at the same coordinate in the next frame of the frame at any timing (an example of the second frame). Similarly, a decrease in pixel value refers to a pixel value (relatively high value) of a pixel at any coordinate in a frame at any timing decreasing to a pixel value (relatively low value) of a pixel at the same coordinate in the next frame of the frame at any timing.

The liquid-crystal display device 100 acquires the above-mentioned backlight correction value Bc using a pair of consecutive frames. For example, a case where the video signal F displays frames in the order of a frame F1, a frame F2, a frame F3, a frame F4, etc. is described. At this time, the liquid-crystal display device 100 acquires the backlight correction value Bc to be used in the period between the frames F1 and F2 using the frames F1 and F2. Similarly, the liquid-crystal display device 100 acquires the backlight correction value Bc to be used in the period between the frames F2 and F3 using the frames F2 and F3, and also acquires the backlight correction value Bc to be used in the period between the frames F3 and F4 using the frames F3 and F4.

The video signal F has the frames F1, F2, F3, F4, etc. in chronological order. However, in the following description of the configuration of each component, for convenience of explanation, the description will focus on various calculations using an arbitrary frame F1 and a frame F2, which is the next frame of the arbitrary frame F1. It is noted that, because the frames F1 and F2 are successive frames in the chronological order, the frame F1 may be referred to as the previous frame and the frame F2 as the subsequent frame. Furthermore, the frame F1, which is the previous frame, and the frame F2, which is the subsequent frame, are examples of the first and second frames. Similarly, the frame F2, which is the previous frame, and the frame F3, which is the subsequent frame, are also examples of the first and second frames, and the frame F3, which is the previous frame, and the frame F4, which is the subsequent frame, are also examples of the first and second frames.

### 2. Description of Each Component

### 2-1. Frame Calculation Processing Unit 1

The frame calculation processing unit 1 has a difference calculation function and a statistical value calculation function.

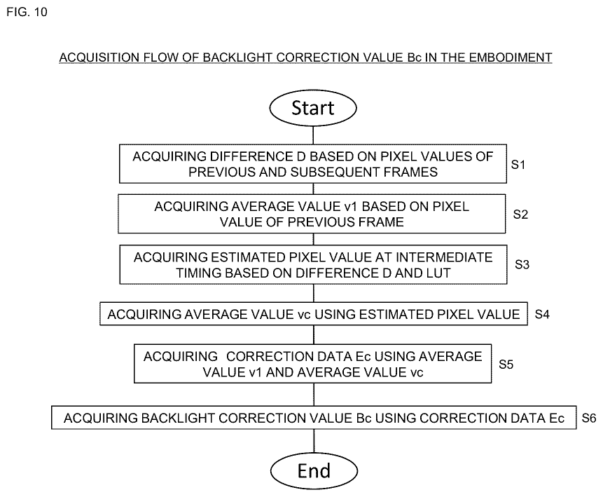

### Difference Calculation Function (Step S1 in FIG. 10: Difference Acquisition Step)

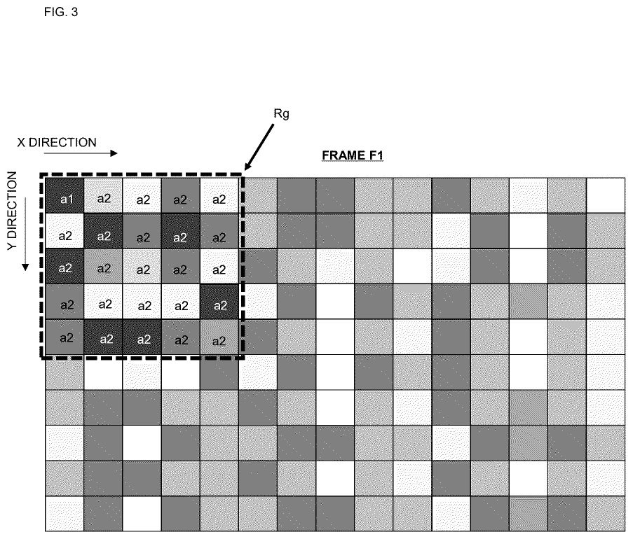

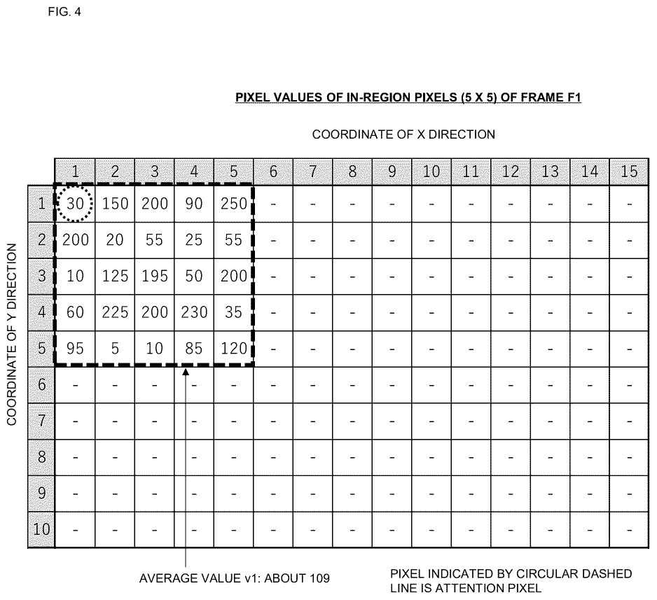

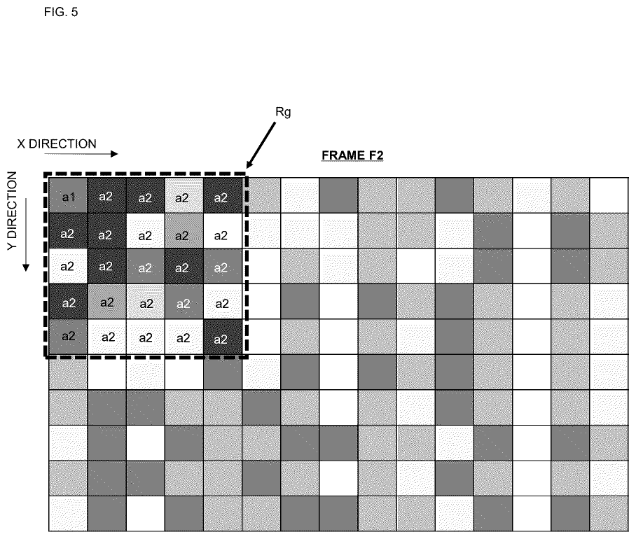

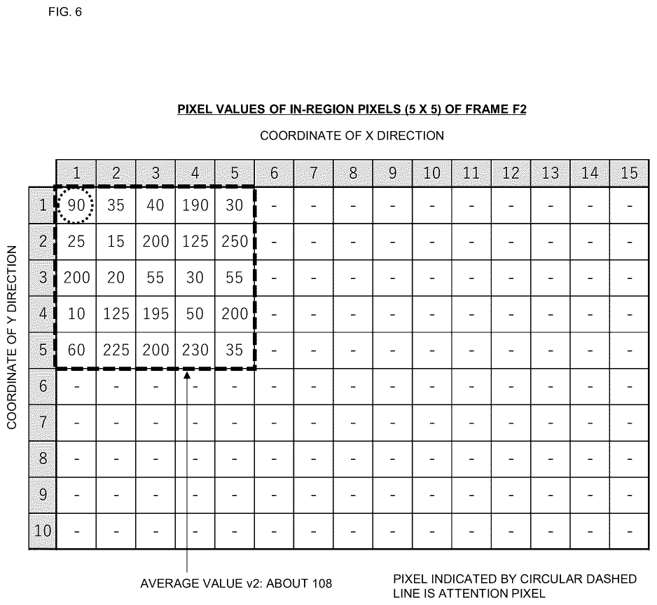

The difference calculation function is a function that acquires the video signal F and acquires a difference D between pixel values (gradation values) of a pair of frames in the video signal F. In the embodiment, the difference D between pixel values is acquired for each coordinate of the previous and subsequent frames (step S1 in FIG. 10: difference acquisition step). In the embodiment, the pixel value (gradation value) is described as having a value of 0 to 255 (8 bits), but is not limited to this. The pixel value of each pixel of the frame F1 shown in FIG. 3 is as shown in FIG. 4, and for example, the pixel value is 30 at the coordinate (1, 1) and 150 at the coordinate (2, 1). The pixel value of each pixel of the frame F2 shown in FIG. 5 is as shown in FIG. 6, and for example, the pixel value is 90 at the coordinate (1, 1) and 35 at the coordinate (2, 1). It is noted that the coordinates (x, y) are defined by the position in the x direction and the position in the y direction perpendicular to the x direction. For example, the difference D between pixel values at the coordinate (1, 1) between the previous and subsequent frames is 90−30=60, and the difference D between pixel values at the coordinate (2, 1) between the previous and subsequent frames is 35−150=−115. In this way, the frame calculation processing unit 1 calculates the difference between pixel values at each coordinate for the frames F1 and F2, which are the previous and subsequent frames.

### Statistical Value Calculation Function (Step S2 in FIG. 10: First Statistical Value Acquisition Step)

The statistical value calculation function is a function for acquiring statistical value (average value in this embodiment) of pixel values of a predetermined region Rg in the previous and subsequent frames (the frames F1 and F2). First, the predetermined region Rg will be described.

In this embodiment, the liquid-crystal of the liquid-crystal display unit 7 is controlled for each pixel, whereas the backlight 7B is controlled for each predetermined region Rg. In other words, the predetermined region Rg has a significance as a control unit of local dimming control. It is noted that the local dimming control refers to a control where a setting value is changed for each area, rather than controlling the entire area of the liquid-crystal display unit 7 with a uniform setting value. The local dimming control is an example of light source control.

It is noted that this embodiment is configured to acquire a backlight correction value Bc based on the correction data Ec, drive the backlight 7B based on the backlight correction value Bc, and suppress the flicker, as described below. Here, in this embodiment, to suppress the flicker, a case will be described as an example where a configuration where the backlight correction value Bc is acquired after performing the local dimming control that is an example of light source control, is provided, but the local dimming control is not a required configuration.

The predetermined region Rg can be set by various methods. For example, The predetermined region Rg may be set to pixels (15 pixels in FIG. 3) forming a line arranged in the x direction shown in FIG. 3, or may be set to pixels (10 pixels in FIG. 3) forming a line arranged in the y direction shown in FIG. 3. In this embodiment, the predetermined region Rg is set to a 5×5 region in the x and y directions.

In the embodiment, the predetermined region Rg includes in-region pixels consisting of a plurality of pixels. The in-region pixels include an attention pixel a1 and a surrounding pixel a2 (non-attention pixel) arranged around the attention pixel a1. The attention pixel a1 is a reference pixel in the predetermined region Rg, and in the embodiment, the attention pixel a1 is located in the upper left corner of the predetermined region Rg. The surrounding pixels a2 are pixels within a range of 5 pixels in the x direction and 5 pixels in the y direction from the attention pixel a1.

In the predetermined region Rg of the attention pixel a1 of the frame F1 shown in FIG. 3, the average value v1 of the pixel values is the average value of the pixel values in the 5×5 range shown in FIG. 4, and is approximately 109. The average value v1 has a significance as a reference because the degree of flicker can be determined by the deviation between the average value v1 and the average value vc described below. For this reason, the average value v1 can also be called the target average value (target average pixel value). In this way, the frame calculation processing unit 1 is configured to acquire the average value v1 as a statistical value (step S2 in FIG. 10: first statistical value acquisition step).

In the predetermined region Rg of the attention pixel a1 of the frame F2 shown in FIG. 5, the average value v2 of the pixel values is the average value of the pixel values in the 5×5 range shown in FIG. 4, and is approximately 108.

It is noted that the average value v1 is an example of the first statistical value. Thus, although there is almost no change between average values v1 and v2, the frames shown in FIGS. 3 and 4 contain a mixture of pixels where pixel values increase and pixels where pixel values decrease. The frame that meet these conditions, including so-called dot mesh image (images where white and black pixels are arranged alternately), are likely to occur the flicker.

The calculation of the statistical value by the frame calculation processing unit 1 and the calculation of the correction data Ec by the correction data acquisition unit 2 described later are performed sequentially for each predetermined region Rg. For example, as shown in FIG. 3, the calculation of the statistical value, etc. in the 5×5 predetermined region Rg with the coordinate (1,1) as the reference (attention pixel) is performed in parallel or sequentially with the calculation of the statistical value, etc. in the 5×5 predetermined region Rg with the coordinate (6,1) as the reference (attention pixel). The same is true for the 5×5 predetermined region Rg with the coordinates (11,1), (1,6), (6,6), and (11,6) as the reference (attention pixel). In other words, the entire region of the liquid-crystal panel 7A is divided into six, and these regions are subject to local dimming control. In the embodiment, the entire area of the liquid-crystal panel 7A is described as being subject to the local dimming control, but it is not limited to this. For example, an arbitrary area where the effect of flicker is not significant may be determined in advance, and this area may be excluded from the local dimming control.

### 2-2 Correction Data Acquisition Unit 2

The correction data acquisition unit 2 has a function of calculating correction data Ec of the pixel value. The correction data acquisition unit 2 is configured to perform a correction data acquisition step. The correction data acquisition step includes step S3 (estimated pixel value acquisition step) shown in FIG. 10, step S4 (second statistical value acquisition step) shown in FIG. 10, and step S5 (correction data calculation step) shown in FIG. 10.

As described below, the correction data acquisition unit 2 acquires the liquid-crystal response characteristic (liquid-crystal response time or liquid-crystal response speed) associated with the pixel values of the frames F1 and F2 from an LUT (lookup table), and acquires the correction data Ec using this liquid-crystal response characteristic. The correction data acquisition unit 2 also acquires the correction data Ec using the estimated pixel value based on this liquid-crystal response characteristic. A method of acquiring the correction data Ec will be described in detail below.

The correction data Ec of the pixel value is a value that indicates to what extent the pixel value (liquid-crystal drive signal Ls of the liquid-crystal drive circuit 5) needs to be corrected to reduce the flicker if the setting value of the backlight 7B is not changed when the frame F1 transitions to the frame F2. In other words, in this embodiment, the correction data Ec of the pixel value related to the liquid-crystal is acquired in advance, and this correction data Ec related to the liquid-crystal is converted into a correction amount (backlight correction value) of the backlight 7B described later to reduce the flicker. For this reason, the correction data Ec is the amount of pixel value related to the liquid-crystal that corresponds to the correction amount of the setting value of the backlight 7B.

The correction data Ec of the pixel value can be acquired by various methods, but one example will be described here. The occurrence of flicker can be understood as the fluctuation of the average luminance in a predetermined range of the liquid-crystal display unit 7 during the transition between previous and subsequent frames. That is, as described above, the average value v1 of the pixel values in the previous frame is 109, and the average value v2 of the pixel values in the subsequent frame is 108, and the two are quite close, but at the intermediate timing (timing between the previous and subsequent frames), when the average value of the pixel values deviates from the average value v1, the flicker occurs. Therefore, in the embodiment, the average value vc (an example of the second statistical value) of the pixel values at the intermediate timing is calculated, and the correction data Ec is calculated using the average value vc. In the embodiment, the intermediate timing is the timing in the middle between the timing of the previous frame and the timing of the subsequent frame. In other words, when the timing of the previous frame is 0 and the timing of the subsequent frame is 1, the intermediate timing corresponds to 0.5. It is noted that the intermediate timing is not limited to being in the middle between the timing of the previous frame and the timing of the subsequent frame. Specifically, the intermediate timing may correspond to, for example, 0.30, 0.35, 0.40, 0.45, 0.50, 0.55, 0.60, 0.65, or 0.70, or may be within a range between any two of the numerical values exemplified here.

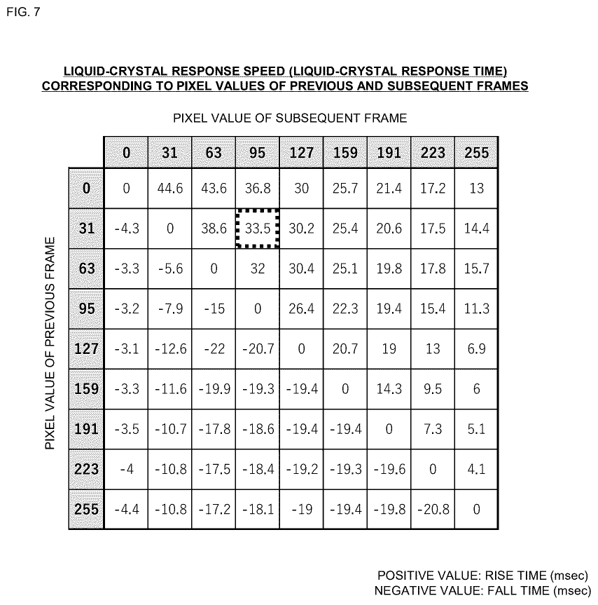

The memory 4 stores a lookup table (LUT) as shown in FIG. 7, which is associated with pixel values of a previous frame (frame F1) and pixel values of a subsequent frame (frame F2). This LUT is configured so that, when a pixel value of an arbitrary coordinate in the previous frame and a pixel value of the arbitrary coordinate in the subsequent frame are determined, the liquid-crystal response characteristic of the arbitrary coordinate can be estimated (acquired). In the embodiment, the liquid-crystal response characteristic corresponds to the liquid-crystal response time from the pixel value of the previous frame to the pixel value of the subsequent frame. In the example shown in FIG. 7, each liquid-crystal response characteristic (liquid-crystal response time) has a pixel value (gradation value) of 32 as one interval, but it is not limited to this. The interval of pixel value (gradation value) of the LUT can be, for example, 1, 2, 4, 8, 16, 32, or 64.

As an example, the liquid-crystal response characteristic (liquid-crystal response time) of the attention pixel a1 in the predetermined region Rg shown in FIG. 3 and FIG. 5 will be described. In the previous frame, the pixel value of the attention pixel a1 is 30 as shown in FIG. 4, so the section 31, which is close to the pixel value 30, is referenced. In the subsequent frame, the pixel value of the attention pixel a1 is 90 as shown in FIG. 6, so the section 95, which is close to the pixel value 90, is referenced. As a result, the liquid-crystal response characteristic (liquid-crystal response time) of this attention pixel a1 is 33.5 msec.

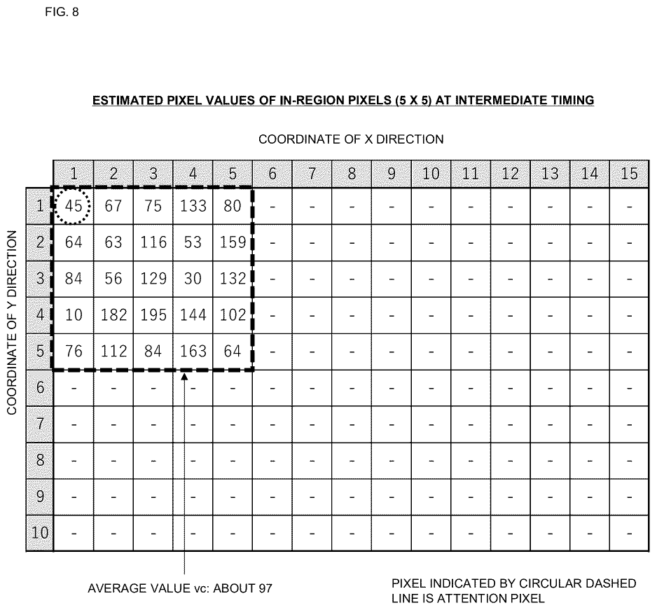

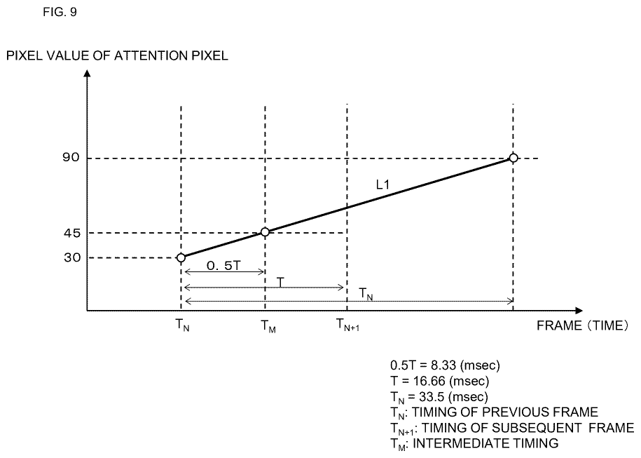

In this embodiment, it is assumed that the liquid-crystal response is linear. In this case, as shown in FIG. 9, the transition of the attention pixel a1 can be expressed as a straight line L1 that satisfies the difference D (the difference between the pixel value 30 and the pixel value 90) and the liquid-crystal response characteristic (liquid-crystal response time): 33.5 msec. The straight line L1 is the transition of the pixel value that is assumed to be real. It can be seen that in this straight line L1, the estimated pixel value predicted at the intermediate timing is 45 (see the coordinate (1,1) in FIG. 8). In other words, the correction data acquisition unit 2 can acquire the estimated pixel value based on the difference D and the liquid-crystal response characteristic (liquid-crystal response time) of the LUT (step S3 in FIG. 10: estimated pixel acquisition step).

By performing this calculation for the pixel at each coordinate, a table where the estimated pixel value for each coordinate is specified such as that shown in FIG. 8 can be obtained. From the table in FIG. 8, it is possible to calculate 97 as the average value vc of the pixel values of the predetermined 5×5 area at the intermediate timing. In other words, the correction data acquisition unit 2 can acquire the average value vc based on the estimated pixel values of the predetermined region Rg (step S4 in FIG. 10: second statistical value acquisition step).

In FIG. 9, T_{N} corresponds to the timing in the previous frame, T_{N+1} corresponds to the timing in the subsequent frame, and T_{M} corresponds to the intermediate timing. T is the time between the previous and subsequent frames and is determined in advance, and is 16.66 msec in this embodiment. 0.5 T is the time from the timing of the previous frame to the intermediate timing, and is half the value of T in this embodiment.

The deviation between the average value v1 of the pixel value and the average value vc of the pixel value corresponds to the degree of the flicker size. In other words, at the intermediate timing, the average value of the pixel value is expected to drop from 109 to 97, which may cause the flicker. In an embodiment, the correction data acquisition unit 2 can calculate the correction data Ec based on the difference between the average value v1 of the pixel value and the average value vc of the pixel value (step S5 in FIG. 10: correction data calculation step). Here, the correction data Ec is 109−97=12.

In the embodiment, the liquid-crystal response characteristic stored in the LUT of the memory 4 is described as the liquid-crystal response time, but it is not limited to this and may be the liquid-crystal response speed. The liquid-crystal response speed corresponds to the time required to transition from one arbitrary pixel value to another arbitrary pixel value, and is therefore essentially the same as the liquid-crystal response time.

### 2-3 Local Dimming Control Unit 3

The local dimming control unit 3 has a backlight correction value calculation function. The local dimming control unit 3 is configured to acquire a backlight correction value based on the correction data Ec acquired by the correction data acquisition unit 2 (step S6 in FIG. 10: backlight correction value acquisition step).

The backlight correction value calculation function converts the correction data Ec related to the pixel value (gradation value) of the liquid-crystal into a correction amount of the backlight (the backlight correction value). As explained above, the correction data Ec is 109−97=12. In other words, when the frame F1 transitions to the frame F2, the average value of the pixel values in a predetermined region Rg may drop from 109 to 97 at the intermediate timing, and it may cause the flicker. For this reason, the setting value of the backlight 7B is increased by an amount corresponding to the correction data (12), which is the difference in this average value. This increase corresponds to the backlight correction value. It is noted that, conversely, if the correction data Ec is a negative value, the setting value of the backlight 7B is decreased, and when the correction data Ec is 0, the setting value of the backlight 7B is not changed.

The backlight drive circuit 6 can be set with a setting value for driving the backlight 7B. The setting value can be determined by the user or is predetermined in the liquid-crystal display device 100. The setting value can be set, for example, between 0 and 1000. When the setting value of the backlight 7B is 0 (minimum value), the luminance of the backlight 7B is 0 cd/m², and when the setting value of the backlight 7B is 1000 (maximum value), the luminance of the backlight 7B is 500 cd/m². Here, it is assumed that the luminance of the backlight 7B changes linearly as the setting value changes from the minimum value to the maximum value. In other words, when the setting value of the backlight 7B increases by 1, the luminance increases by 0.5 cd/m². For example, when the setting value of the backlight 7B is 500, the luminance of the backlight 7B is 250 cd/m². Here, for convenience of explanation, it is assumed that the setting value of the backlight 7B is 500.

Here, in order to acquire the backlight correction value Bc, the correction data Ec is converted to luminance (unit: cd/m²). The conversion can be calculated using the following formula: (luminance of the backlight 7B)×(the correction data Ec)+(possible pixel value). Specifically, the luminance of the backlight 7B is 250 cd/m², the correction data Ec is 12, and the possible pixel value is 256, so the backlight correction value is approximately 12 cd/m². The luminance of the backlight 7B increases by 0.5 cd/m² every time the setting value is increased by 1, so the backlight drive circuit 6 drives the backlight 7B to increase the setting value from 500 by 24 (to increase the luminance by 12 cd/m²). It is noted that the calculations here are rough and are just an example, but when the luminance increments of the setting value of the backlight 7B is finer, it is possible to reduce the flicker more accurately even when the number of significant digits for the decimal point in the backlight correction value increases. In this way, in the 5×5 predetermined region Rg with coordinates (1, 1) as the reference (attention pixel), the setting value of the backlight 7B is determined to be 524. For other 5×5 predetermined regions Rg with coordinates (6, 1), etc. as the reference (attention pixel), the above calculation is performed and the setting value is determined in a similar manner.

In addition, the period for controlling the backlight 7B using the backlight correction value Bc can be set to be from the timing (T_{N}) of the start of the frame F1 to the timing (T_{N+1}) of displaying the frame F2 that is the subsequent frame, centered around the intermediate timing (T_{M}).

### 2-4 Memory 4, Liquid-Crystal Drive Circuit 5, and Backlight Drive Circuit 6

The memory 4 stores the LUT (look-up table) shown in FIG. 7.

The liquid-crystal drive circuit 5 generates a liquid-crystal drive signal Ls for controlling the liquid-crystal of the liquid-crystal panel 7A for each pixel based on the video signal, and controls the liquid-crystal panel 7A.

The backlight drive circuit 6 generates a dimming signal Ds corresponding to the setting value of the backlight 7B based on the backlight correction value Bc, and controls the backlight 7B. The backlight drive circuit 6 is configured to control synchronously with the liquid-crystal drive circuit 5. In other words, the backlight 7B is controlled by the dimming signal Ds in synchronization with the liquid-crystal drive circuit 5 controlling the liquid-crystal of the liquid-crystal panel 7A to display each frame at each timing.

### 2-5 Liquid-Crystal Display Unit 7

The liquid-crystal display unit 7 has the liquid-crystal panel 7A and the backlight 7B.

The LED of the backlight 7B is arranged on the back surface of the liquid-crystal panel 7A and are of the direct type. In other words, the backlight 7B is configured to shine light directly onto the liquid-crystal panel 7A from the back surface side of the liquid-crystal panel 7A.

In the embodiment, the backlight 7B is described as being of the direct type arranged on the back surface of the liquid-crystal panel 7A, but it is not limited to this, and the backlight 7B may be of the edge type. In this case, the backlight 7B can be configured, for example, with edge type LED arranged on each of the four sides of the liquid-crystal panel 7A. Even when the backlight 7B is of the edge type, it is possible to control the light source on an area basis.

### 3. Effect of the Embodiment

The local dimming control unit 3 of the liquid-crystal display device 100 according to the embodiment is configured to acquire the backlight correction value Bc based on the correction data Ec for reducing the occurrence of flicker. When the frame displayed on the liquid-crystal display unit 7 changes from the frame F1 as the previous frame to the frame F2 as the subsequent frame, the backlight 7B is driven at the setting value that takes into account this backlight correction value Bc, thereby reducing the flicker.

Here, a method of controlling the pixel value themselves (changing the pixel values themselves) to suppress the flicker is also considered. In this case, controlling the pixel values will, for example, slow down the rise and fall of the pixel value of each pixel. This slows down the response characteristic of the liquid-crystal, increasing the possibility of causing a phenomenon called “tailing.” Here, “tailing” refers to the blurring of an image that occurs when an object to be displayed in a frame moves during the process of displaying a plurality of frames. The liquid-crystal display device 100 according to the embodiment is not configured to control the pixel values of the frames themselves (changing the pixel values themselves), but rather to acquire the backlight correction value Bc for controlling the backlight 7B. This makes it possible to avoid affecting the response characteristic of the liquid-crystal and suppress the occurrence of a phenomenon where the appearance of a displayed image changes, such as “tailing.”

### 3. Modified Example

### 3-1. Modified example 1: Determining Whether to Correct Predetermined Region Rg According to Flicker Amount

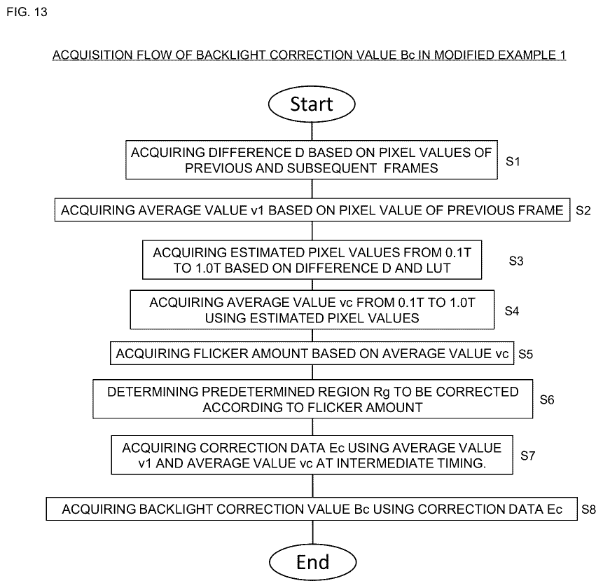

In the embodiment, a form where the correction data Ec and backlight correction value Bc for each predetermined region Rg are uniformly acquired was described, but it is not limited to this. As shown in FIG. 13, the liquid-crystal display device 100 may perform a correction determination step S6, which will be described later, and determine whether to use the correction data Ec and backlight correction value Bc according to the degree where the flicker occurs (flicker amount).

Here, the frame where the flicker is likely to occur will be described.

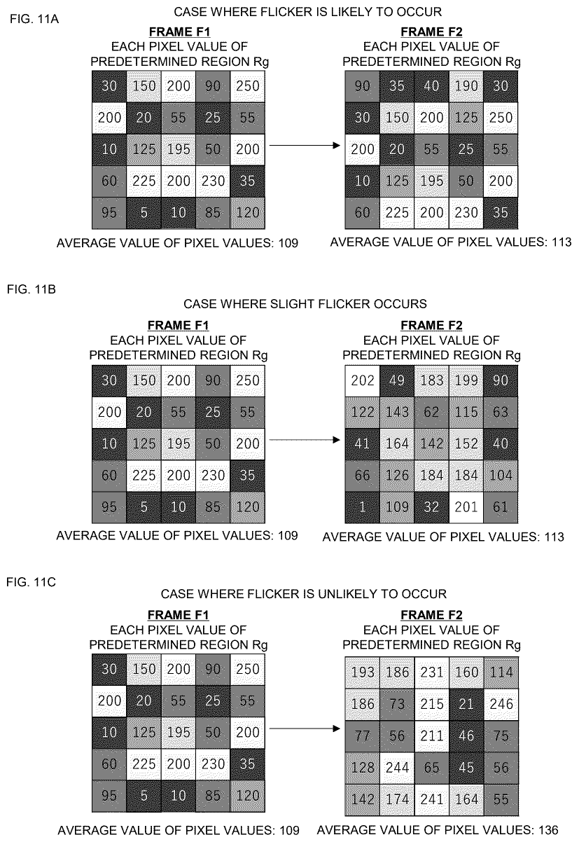

The predetermined region Rg of the frame F1 in FIGS. 11A to 11C includes many arrangements of alternating white and black pixels, and can be said to be somewhat similar to a dot mesh image.

On the other hand, the predetermined region Rg of the frame F2 in FIG. 11A is obtained by shifting the entire predetermined region Rg of the frame F1 down by one position, and the pixel values of the pixels in the top row are 90, 35, 40, 190, and 30. In the case of FIG. 11A, because pixels with a white-biased pixel value tend to become pixels with a black-biased pixel value, and pixels with a black-biased pixel value tend to become pixels with a white-biased pixel value, although the change in the average value of the pixel values between the previous and subsequent frames is small, the difference in liquid-crystal response speed is likely to be apparent. In such a situation, the flicker amount, which will be described later, increases, and the flicker is likely to occur.

The predetermined region Rg of the frame F2 in FIG. 11B is set so that the change in the average value of the pixel values between the previous and subsequent frames is small, just like in FIG. 11A. However, in the predetermined region Rg of frame F2 in FIG. 11B, the distribution of pixel values is more random than in the frame F2 in FIG. 11A, making it less likely for the flicker to occur than in the case of FIG. 11A.

In the predetermined region Rg of the frame F2 in FIG. 11C, the average value of the pixel values is significantly greater than the average value of the pixel values of the predetermined region Rg of the frame F1, making it less likely for the flicker to occur.

Here, the degree where the flicker occurs is defined by the flicker amount. The amount of flicker corresponds to the degree where the flicker occurs in a predetermined region Rg when the previous frame transitions to the subsequent frame. The flicker amount can be expressed as the sum of the differences between the transition line G of the average value of estimated pixel values at each predetermined timing and the reference line RL, in other words, it corresponds to the area formed by the transition line G and the reference line RL.

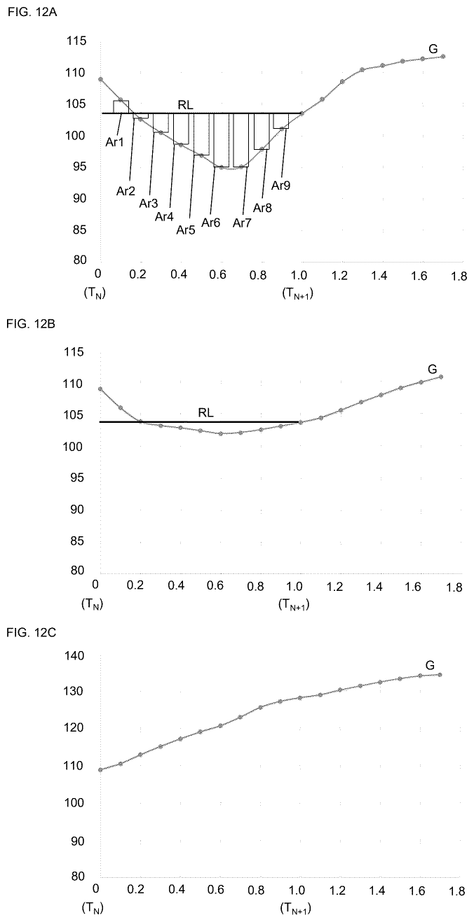

In this modified example, the flicker amount is the sum of differences Ar1 to Ar9 shown in FIG. 12A. Comparing the cases of FIG. 11A and FIG. 11B, this sum is larger in FIG. 12A, which corresponds to FIG. 11A, so the degree where the flicker occurs is greater in the case of FIG. 11A. The transition line G of the average value, etc. are described below.
Each value of the transition line G of the average value is the same as the average value vc of the estimated pixel values of the 5×5 predetermined region described in the embodiment. The average value vc described in the embodiment was the value at the timing of 0.5 T. The transition line G of the average value in this modified example is obtained by calculating the average value vc in increments of 0.1 T, plotting it, and connecting it with a line. In other words, the time between the previous and subsequent frames (see time T in FIG. 9) is divided into n equal parts (n=10 in this case), and the average value vc is plotted for each of the n equal parts of time to obtain the transition line G. As described in the embodiment, if the liquid-crystal response is assumed to be linear, and the difference D between the pixel values of the previous and subsequent frames and the liquid-crystal response characteristic (see FIG. 7) are known, the pixel value of each coordinate as shown in FIG. 8 can be estimated in increments of 0.1 T, and as a result, the average value vc can be calculated in increments of 0.1 T.
The reference line RL is a horizontal line passing through the timing of the frame F2 as the subsequent frame. In this modified example, the degree where the flicker occurs is determined by the deviation of the transition line G from this reference line RL. Difference Ar1 is the difference between the value of the transition line G of the average of estimated pixel values at a timing of 0.1 T and the value of the reference line RL. Similarly, differences Ar2 to Ar9 are the differences between the value of the transition line G of the average value of estimated pixel values (average value of estimated pixel values) at timings of 0.2 T to 0.9 T and the value of the reference line RL.

Next, with reference to FIG. 13, the flow of a method for acquiring the backlight correction value Bc in this modified example will be described.

In step S1 (difference acquisition step), the frame calculation processing unit 1 acquires the difference D of pixel values for each coordinate of the previous and subsequent frames (the frames F1, F2), as in the embodiment.

In step S2 (first statistical value acquisition step), the frame calculation processing unit 1 acquires an average value v1 of estimated pixel values as a statistical value for each predetermined region Rg based on the previous frame (the frame F1), as in the embodiment.

In step S3 (estimated pixel value acquisition step), the correction data acquisition unit 2 acquires the estimated pixel value of each pixel at each timing based on the difference D and the LUT (see FIG. 7). That is, in the step S3, 10 matrices of estimated pixel values as shown in FIG. 8 are generated. It is noted that each timing here refers to the timing of 0.1 T, 0.2 T, 0.3 T, 0.4 T, 0.5 T, 0.6 T, 0.7 T, 0.8 T, 0.9 T, and 1.0 T.

In this modified example, as in the embodiment, it is assumed that the liquid-crystal response is linear. The method of calculating the estimated pixel value at each timing is the same as the method described in FIG. 9 in the embodiment. In other words, the section from T_{N} to T_{N+1} shown in FIG. 9 is divided into 10 sections, and the value of the straight line L1 in each divided section is the estimated pixel value at each timing of the pixel at coordinates (1, 1) which is the attention pixel. In the same manner, the estimated pixel values of the other pixels can be acquired.

In step S4 (second statistical value acquisition step), the correction data acquisition unit 2 acquires the average value vc of the estimated pixel values for each predetermined region Rg at each timing (0.1 T, 0.2 T, 0.3 T, 0.4 T, 0.5 T, 0.6 T, 0.7 T, 0.8 T, 0.9 T, and 1.0 T).

In step S5 (flicker amount acquisition step), the correction data acquisition unit 2 acquires the flicker amount for each predetermined region Rg based on the average value vc of the estimated pixel values at each timing acquired in the step S4. The flicker amount for each predetermined region Rg can be acquired by summing the differences Ar1 to Ar9, as described above.

In step S6 (correction determination step), the correction data acquisition unit 2 determines the predetermined region Rg where the correction of the backlight is to be performed based on the flicker amount acquired in the step S5. When the flicker amount of the predetermined region Rg is equal to or greater than a predetermined threshold, the correction data acquisition unit 2 determines that the predetermined region Rg is the predetermined region Rg where the correction is to be performed. On the other hand, when the flicker amount of the predetermined region Rg is less than the predetermined threshold, the correction data acquisition unit 2 determines that the predetermined region Rg is the predetermined region Rg where the correction is not to be performed.

For the predetermined region Rg where it was determined that the correction is to be performed, the correction data Ec and the backlight correction value Bc are acquired in a later step.

On the other hand, for the predetermined region Rg where it was determined that the correction is not be performed, the correction data Ec and the backlight correction value Bc are not acquired in a later step.

In step S7 (correction data calculation step), the correction data acquisition unit 2 calculates the correction data Ec for the predetermined region Rg where it was determined that the correction is to be performed, based on the difference between the average value v1 of the pixel value and the average value vc of the estimated pixel value at the intermediate timing, as in the embodiment. It is noted that, since the average value vc of the estimated pixel value vc at 0.5 T (intermediate timing) was already acquired in the step S4, the correction data acquisition unit 2 can use this already acquired average value vc.

It is noted that the correction data acquisition unit 2 does not calculate the correction data Ec for the predetermined region Rg where it was determined that the correction is not to be performed.

In step S8 (backlight correction value acquisition step), the local dimming control unit 3 acquires the backlight correction value Bc based on the correction data Ec acquired by the correction data acquisition unit 2. It is noted that the method where the local dimming control unit 3 converts the correction data Ec into the backlight correction value Bc is the same as in the embodiment.

### 3-2 Modified Example 2: Backlight 7B can be Controlled for Each Pixel

In the embodiment, the control using the backlight correction value Bc is performed for the entire region of the predetermined region Rg, but it is not limited to this. When the minimum area where the backlight 7B can be independently controlled is narrower than the predetermined region Rg, the predetermined region Rg can be divided into desired areas narrower than the predetermined region Rg. As an example, the area will be described as a region for each pixel. In this way, where the minimum area where the backlight 7B can be independently controlled is narrow, it becomes possible to correct the backlight 7B by targeting pixels in the predetermined region Rg that are likely to be particularly affected by the flicker, and the effect of reducing the flicker is expected more reliably. In other words, in method 1 of this modified example 2, specific pixels that have a high flicker reduction effect when the control using the backlight correction value Bc is performed are extracted.

It is noted that the configuration of the method 1 of this modified example 2 can be performed in at least two ways, and each will be described separately below.

### 3-2-1 Method 1 of Modified Example 2: When Backlight Correction Value Bc is Different for Each Pixel

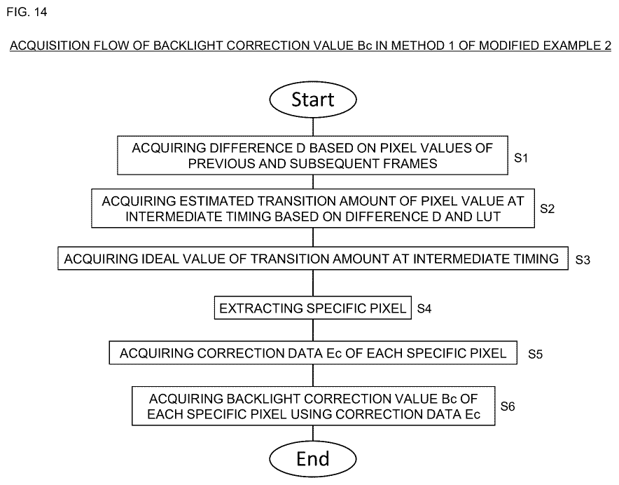

The calculation flow for the backlight correction value Bc in the method 1 of the modified example 1 (see FIG. 14) does not have step S2 in the embodiment (see FIG. 10), but instead includes new steps S3 (ideal value acquisition step) and S4 (specific pixel extraction step) shown in FIG. 4.

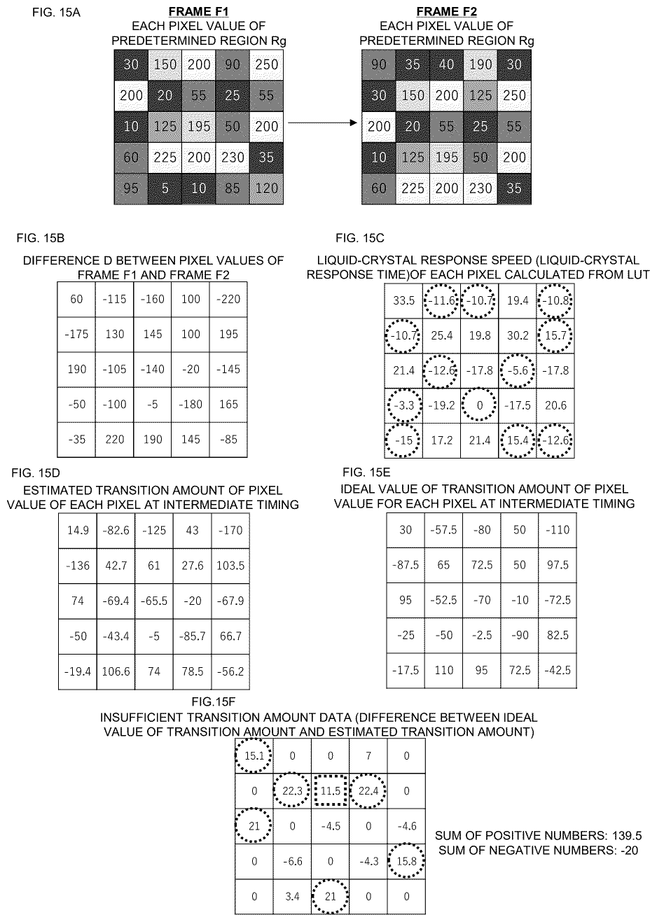

The flow of a method for acquiring the backlight correction value Bc in this modified example will be described with reference to FIG. 14. It is noted that this modified example will be described assuming that the frames F1 and F2 shown in FIG. 15A are used. The pixel value shown in FIG. 15A is the same as the pixel value in FIGS. 4 and 6.

In step S1 (difference acquisition step), the frame calculation processing unit 1 acquires the difference D of the pixel value for each coordinate of the previous and subsequent frames (the frames F1 and F2) in the same manner as in the embodiment. The acquired difference D is as shown in FIG. 15B.

In step S2 (estimated transition amount acquisition step), the correction data acquisition unit 2 acquires an estimated transition amount of each pixel at the intermediate timing based on the difference D and the LUT (see FIG. 7). The estimated transition amount is the difference between the estimated pixel value at the intermediate timing (see FIG. 8) and the pixel value of the frame F1, which is the previous frame. Therefore, the estimated transition amount acquisition step of this step S2 is substantially the same as the estimated pixel value acquisition step described in the embodiment.

It is noted that by using the LUT shown in FIG. 7, the liquid-crystal response characteristic (liquid-crystal response time) of each pixel shown in FIG. 15C can be obtained. By using this liquid-crystal response characteristic (liquid-crystal response time) of each pixel, the estimated transition amount of each pixel shown in FIG. 15D can be obtained.

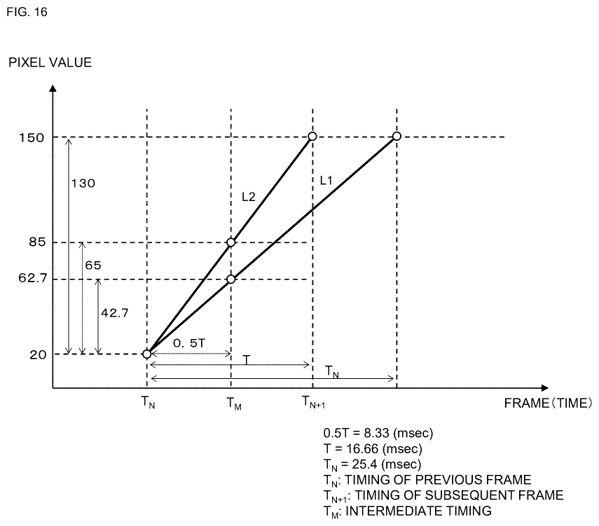

The estimated transition amount will be specifically described with reference to FIG. 16. Here, the pixel at the coordinate (2, 2) will be described as an example. The straight line L1 shown in FIG. 16 has the same meaning as the straight line L1 shown in FIG. 9 described in the embodiment. The pixel at the coordinate (2, 2) changes from a pixel value of 20 to a pixel value of 150. The LUT shown in FIG. 7 shows that the liquid-crystal response characteristic at the coordinate (2, 2) is 25.4 msec. As a result, it can be seen that the pixel value expected at the intermediate timing for the straight line L1 shown in FIG. 16 is 62.7. The estimated transition amount at the intermediate timing for the coordinates (2, 2) is therefore 42.7, as shown in FIG. 15D. For other coordinates, the estimated transition amount at the intermediate timing can be acquired by similar calculation.

In step S3 (ideal value acquisition step), the correction data acquisition unit 2 acquires an ideal value of the transition amount. The ideal value of the transition amount is the difference between the pixel value at the intermediate timing and the pixel value of the previous frame when the pixel value of each pixel transitions ideally from the previous frame to the subsequent frame.

It is noted that, by assuming that the ideal transition is a linear transition from the pixel value of the previous frame to the pixel value of the subsequent frame, the estimated transition amount of each pixel shown in FIG. 15E can be obtained.

Specifically, the ideal transition can be represented by a straight line connecting the pixel value of the previous frame and the pixel value of the subsequent frame, as shown by the straight line L2 in FIG. 16. That is, in reality, it takes 25.4 msec for the pixel value to rise from 20 to 150, but ideally it is desired that the rise takes 16.66 msec. It can be seen from this straight line L2 that the pixel value is 85 at the intermediate timing. Therefore, the ideal value of the transition amount of the pixel at the coordinate (2, 2) is 85−20=65. For other coordinates, the ideal transition amount can be acquired by similar calculation.

In step S4 (specific pixel extraction step), the correction data acquisition unit 2 extracts a specific pixel based on the difference between the ideal value of the transition amount (FIG. 15E) and the estimated transition amount of the pixel value (FIG. 15D). Specifically, the correction data acquisition unit 2 extracts the specific pixel based on the insufficient transition amount data shown in FIG. 15F.

The value of the insufficient transition amount data changes according to whether the absolute value of the liquid-crystal response time shown in FIG. 15C is greater than or equal to the time between the previous and subsequent frames (16.66 msec). When the absolute value of the liquid-crystal response time is equal to or less than the time, it means that the pixel value transitions to the pixel value of the subsequent frame within the time. It is noted that in FIG. 15C, the pixel where absolute value of the liquid-crystal response time is equal to or less than the time between the previous and subsequent frames (16.66 msec) are highlighted by being surrounded by a dashed circle. Since it is considered that the correction is not required for such pixels, the insufficient transition amount data is set to 0. On the other hand, when the absolute value of the liquid-crystal response time is greater than the time between the previous and subsequent frames, the correction is required. The insufficient transition amount data for such pixels can be acquired based on the difference between the ideal value of the transition amount (FIG. 15E) and the estimated transition amount of the pixel value (FIG. 15D).

Here, the sum of the positive numbers of the insufficient transition amount data shown in FIG. 15F is 139.5, and the sum of the negative numbers is 20. The correction data acquisition unit 2 sets the absolute values of the insufficient transition amount data with the larger sum, positive or negative, to 0 in order from the largest absolute value until the magnitude relationship of these sums is reversed. In other words, in FIG. 15F, since the sum of the positive numbers is large, the positive numbers are set to 0 in order from the largest absolute value. Specifically, 22.4 at the coordinate (4,2), 22.3 at the coordinate (2,2), 21 at the coordinate (1,3) and the coordinate (3,5), and 15.1 at the coordinate (1,1) are set to 0 in order. At this time, the sum of the remaining positive numbers is 21.9. Next, when 11.5 at the coordinate (3,2) is set to 0, the sum of the positive numbers and the sum of the negative numbers are reversed. For this reason, the correction data acquisition unit 2 stops the calculation of setting the insufficient transition amount data to 0, and extracts the coordinate related to the calculation before the magnitude relationship between the sum of the positive numbers and the sum of the negative numbers is reversed as the specific pixel. In this explanation, the specific pixels are coordinates (4, 2), (2, 2), (1, 3), (3, 5), and (1, 1). It is noted that in FIG. 15F, the specific pixels are highlighted by being surrounded by dashed circles, and the pixel where the magnitude relationship between the sum of the positive numbers and the sum of the negative numbers is reversed by setting the value to 0 are highlighted by being surrounded by dashed squares.

In this way, with regard to the insufficient transition amount data based on the difference between the ideal value of the transition amount and the estimated transition amount of the pixel value, the correction data acquisition unit 2 sets the insufficient transition amount data of the greater sign of the sum of the positive numbers or the sum of the negative numbers to 0 in order from the larger of the insufficient transition amount data of the greater sign, until the sum of the positive numbers and the sum of the negative numbers are reversed. The correction data acquisition unit 2 then extracts the pixel at the coordinate set to 0 as the specific pixel.

In step S5 (correction data calculation step), the correction data acquisition unit 2 calculates the correction data Ec for each pixel extracted as the specific pixel. As the correction data Ec, the insufficient transition amount data shown in FIG. 15F can be used. For example, for the coordinate (1, 4), the correction data Ec is 7. It is noted that the correction data acquisition unit 2 does not acquire the correction data Ec for the pixel in the predetermined region Rg that was not extracted as the specific pixel.

In step S6 (backlight correction value acquisition step), the local dimming control unit 3 acquires the backlight correction value Bc for each specific pixel based on the correction data Ec for each specific pixel. The method where the local dimming control unit 3 converts the correction data Ec for the specific pixel into the backlight correction value Bc is the same as in the embodiment.

In the method 1 of the present modified example 2, a form where the specific pixel is extracted for each predetermined region Rg was described, but it is not limited to this, and the specific pixel may be extracted directly from the entire liquid-crystal panel 7A.

In the method 1 of the present modified example 2, the intermediate timing is set to 0.5 T, but it is not limited to this, and as explained in the embodiment, other timings may be used.

### 3-2-2 Method 2 of Modified Example 2: When Backlight Correction Value Bc is Common

In the above 3-2-1, the specific pixel is extracted and the correction data Ec is acquired for each specific pixel, but common correction data Ec can also be used for the specific pixels. It is noted that the common correction data Ec may be, for example, the average value, median value, or histogram of the insufficient transition amount data of the specific pixels.

It is noted that the operation in the case of method 2 of the modified example 2 is basically the same as that in the flowchart of FIG. 14 for the method 1, except that in step S5, the common correction data Ec is acquired for the specific pixels, and in step S6, the common backlight correction value Bc is acquired based on the common correction data Ec.

It is noted that the method 1 or the method 2 of the modified example 2 may be combined with, for example, the configuration of modified example 1. That is, the modified example 1 may determine a predetermined region Rg to be corrected, and the specific pixels may be extracted from the determined predetermined region.

### 3-3 Modified Example 3: Regarding Statistical Value

In the embodiment, various calculations are performed using the average value v1 and the average value v2 (an example of the first statistical value) and the average value vc (an example of the second statistical value), but it is not limited to this. In addition to the average value, the median value or a histogram may be used.

### 3-4 Modified Example 4: Method of Acquiring Liquid-Crystal Response Characteristic

In the embodiment, a method of acquiring the estimated pixel value using the liquid-crystal response characteristic stored in the LUT was described, but it is not limited to this. The liquid-crystal response characteristic may be calculated each time using an arithmetic formula that can acquire the liquid-crystal response characteristic based on the pixel values of the previous and subsequent frames.

### 3-5. Modified Example 5: Regarding Light Source Control

In the embodiment, it was explained that the backlight correction value Bc is acquired after performing the local dimming control as an example of the light source control, but it is not limited to this, and the light source control is not the local dimming control. Specifically, in the embodiment, various values are calculated for each area (each predetermined region Rg) and the backlight is controlled, but in the modified example 5, various values are calculated when the entire backlight 7B is grouped together, and the backlight is controlled. In other words, the configuration of modified example 5 corresponds to expanding the predetermined region Rg described in the embodiment to the entire region of the liquid-crystal panel 7A (the entire 15×10 region in the frame of FIGS. 3 and 5).

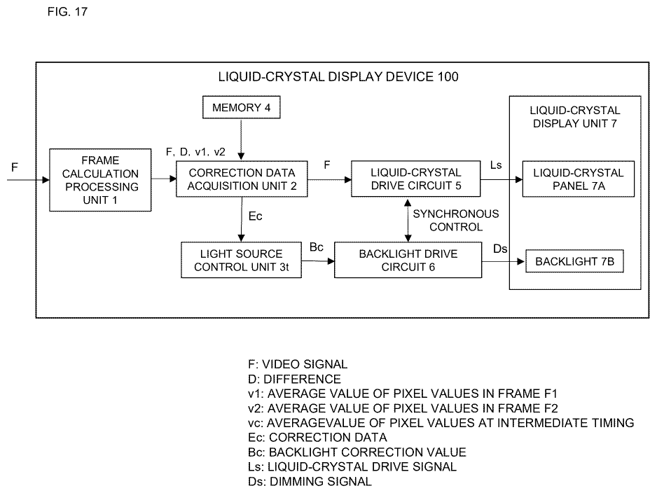

In the modified example 5, as shown in FIG. 17, the liquid-crystal display device 100 includes a light source control unit 3t instead of the local dimming control unit 3 shown in FIG. 2 of the embodiment.

In the present modified example 5, the difference calculation function of the frame calculation processing unit 1 is the same as in the embodiment. The statistical value calculation function of the frame calculation processing unit 1 is applied to the entire 15×10 region shown in FIG. 3 and FIG. 5. It is noted that the calculation method of the average value v1 and the average value v2 is the same as in the embodiment.

In the present modified example 5, the calculation method of the average value vc in the correction data acquisition unit 2 is the same as in the embodiment. That is, as shown in FIG. 8, the correction data acquisition unit 2 calculates the average value vc of the pixel values of the entire 15×10 region at the intermediate timing using a table where the estimated pixel value of each coordinate is specified. Then, the correction data acquisition unit 2 can acquire the correction data Ec based on the difference between the average value v1 and the average value vc.

In the present modified example 5, the method of acquiring the backlight correction value Bc of the light source control unit is the same as in the embodiment. That is, the light source control unit can acquire the backlight correction value Bc to be applied to the entire 15×10 region based on the correction data Ec acquired by the correction data acquisition unit 2.

The present modified example 5 can also be combined with the modified example 1. That is, the liquid-crystal display device 100 according to the modified example 5 can be configured to determine whether or not to perform backlight correction for the entire 15×10 region based on the flicker amount.

Moreover, the modified example 5 can also be combined with the method 1 and the method 2 of the modified example 2. That is, the liquid-crystal display device 100 according to the modified example 5 may acquire the backlight correction value Bc for each pixel in the entire 15×10 region.

Moreover, the modified example 5 can also be combined with the modified example 1, and the method 1 or the method 2 of the modified example 2.

### REFERENCE SIGNS LIST

1: frame calculation processing unit, 2: correction data acquisition unit, 3: local dimming control unit (light source control unit), 3t: light source control unit, 4: memory, 5: liquid-crystal drive circuit, 6: backlight drive circuit, 7: liquid-crystal display unit, 7A: liquid-crystal panel, 7B: backlight, 100: liquid-crystal display device, 200: output device

1. A liquid-crystal display device that performs a light source control of a backlight, comprising:
a correction data acquisition unit; and
a light source control unit, wherein
the liquid-crystal display device is configured to reduce a flicker caused by a difference in liquid-crystal response speed between a pixel where a pixel value increases and a pixel where a pixel value decreases during a transition from a first frame to a second frame,
the correction data acquisition unit is configured to acquire a correction data for reducing an occurrence of the flicker based on the pixel values of the first and second frames,
the light source control unit is configured to acquire a backlight correction value based on the correction data, and
the backlight correction value is used for the light source control of the backlight during a predetermined period between the first and second frames.

2. The liquid-crystal display device of claim 1, wherein
the correction data acquisition unit acquires the correction data using a liquid-crystal response characteristic where the pixel values of the first frame and the pixel values of the second frame are associated, and
the liquid-crystal response characteristic is a liquid-crystal response speed or a liquid-crystal response time.

3. The liquid-crystal display device of claim 2, wherein
the correction data acquisition unit acquires the correction data using an estimated pixel value based on the liquid-crystal response characteristic,
the estimated pixel value is a pixel value at an intermediate timing, and
the intermediate timing is a timing between the first and second frames.

4. The liquid-crystal display device of claim 1, wherein
the light source control unit is configured to acquire the backlight correction value to be applied to a pixel of in-region pixels based on the correction data of the in-region pixels, and
the in-region pixels are composed of a plurality of pixels included in a predetermined region of the first and second frames.

5. The liquid-crystal display device of claim 4, wherein
the correction data acquisition unit is configured to acquire the correction data based on a difference between a first and a second statistical value,
the first statistical value is a statistical value based on pixel values of the plurality of pixels of the in-region pixels in the first frame,
the second statistical value is a statistical value based on pixel values of the plurality of pixels of the in-region pixels at an intermediate timing, and
the intermediate timing is a timing between the first and second frames.

6. The liquid-crystal display device of any one of claim 5, wherein
the statistical value is a mean value, a median value, or a value acquired based on a histogram.

7. The liquid-crystal display device of claim 4, wherein
the correction data acquisition unit is configured to extract a specific pixel of the in-region pixels, and is configured to acquire the correction data for the extracted specific pixel, and
the light source control unit is configured to acquire the backlight correction value based on the correction data for the specific pixel.

8. The liquid-crystal display device of claim 4, wherein
the correction data acquisition unit is configured to acquire a flicker amount for each of the predetermined regions, and is configured to determine whether or not to use the correction data and the backlight correction value for the predetermined regions based on the flicker amount, and
the flicker amount corresponds to a degree where the flicker occurs in the predetermined regions during the transition from the first frame to the second frame.

9. The liquid crystal display device of claim 1, wherein
the first and second frames are dot mesh images.

10. The liquid-crystal display device of claim 1, wherein
the light source control is a local dimming control, and
the backlight correction value is used for the local dimming control of the backlight corresponding to at least a pixel including an attention pixel during a predetermined period between the first and second frames.

11. A liquid-crystal display method that that performs a light source control of a backlight, comprising:
a correction data acquisition step; and
a backlight correction value acquisition step, wherein
the liquid-crystal display method reduces a flicker caused by a difference in liquid-crystal response speed between a pixel where a pixel value increases and a pixel where a pixel value decreases during a transition from a first frame to a second frame,
in the correction data acquisition step, a correction data for reducing an occurrence of the flicker is acquired based on the pixel values of the first and second frames,
in the backlight correction value acquisition step, a backlight correction value is acquired based on the correction data, and
the backlight correction value is used for the light source control of the backlight during a predetermined period between the first and second frames.

12. A non-transitory computer readable medium that stores a program causing a computer to execute the liquid-crystal display method of claim 11.
